(19) United States
(12) Patent Application Publication
(10) Pub. No.: US 2004/0171784 A1
(43) Pub. Date: Sep. 2, 2004

(54) Internal mold release compositions

(76) Inventors: Trent A. Shidaker, Troy, MI (US); David W. Bareis, Shelby Township, MI (US)

Correspondence Address: Patent Counsel, 286 Mantua Grove Road, West Deptford, NJ, 08066-1732, US

(21) Appl. No.: 10/799,234

(22) Filed: Mar. 12, 2004

Related U.S. Application Data
(63) Continuation-in-part of application No. 09/954,311, filed on Sep. 13, 2001, now abandoned.
Application No. 09/954,311 is a continuation of application No. PCT/US00/05768, filed on Mar. 3, 2000.
(60) Provisional application No. 60/124,456, filed on Mar. 15, 1999.

(51) Int. Cl. C08L 75/00; C08K 3/00

(52) U.S. Cl. 528/44; 525/403; 524/589

(57) ABSTRACT

Internal mold release systems that include an internal mold release agent that includes any one of fatty acids, fatty acid esters and metal carboxylates, and employ a poly(dimethylsiloxane) surfactant with the following formula:

(CH₃)₃Si—O—[(CH₃)₂Si—O—]ₙ—[CH₃—Si(R)—O—]ₘ—Si(CH₃)₃

wherein,

R=—(CH₂)₃—O—[EO]ₓ—R′;

R′ is H; C₁ to C₂₀ alkyl; or C₆ to C₂₅ aryl;

x is a number from greater than 1 up to about 24;

m is a number from 1 to about 25; and

n is a number from 0 to about 100.

Isocyanate compositions, isocyanate reactive compositions and polyurethane reaction systems that employ the surfactant also are disclosed.

### CROSS-REFERENCE TO RELATED APPLICATIONS

This application is a continuation of co-pending International Application No. PCT/US00/05768 filed Mar. 3, 2000, which designates the US. This application is also a continuation-in-part of Ser. No. 09/954,311 filed Sep. 13, 2001.

### TECHNICAL FIELD

The present invention relates to internal mold release agents and surfactants, and to polyurethane reaction mixtures which employ internal mold release agents and surfactants.

### BACKGROUND ART

Developments in the chemistry of the polymer systems used in SRIM processes have resulted in urethane and urethane-urea polymers which cure to be demolded within about 50-90 seconds after injection into a mold. The urethane polymers, however, bond tenaciously to the metal surfaces of the mold. This makes it necessary to utilize a release agent so that a urethane polymer products can be removed quickly and easily from the metal mold without damaging those products.

To facilitate removal of the cured urethane polymer products, external mold release agents have been applied directly to the metal surfaces of the mold. Application of the external mold release agent requires a minimum of 30-60 seconds and must be repeated at least after manufacture of every one to five parts. This increases the part to part cycle time by as much as 50%. Additionally, this repeated application of mold release agent often causes excessive build up on areas surrounding the mold surface or on the mold surface itself. The mold therefore must be periodically cleaned. This is both time consuming and costly for the part manufacturer.

Mold release agents which are contained in the reaction systems, i.e., internal mold release agents are advantageous in eliminating such difficulties. Various internal mold release agents have been proposed. For example, polysiloxane release agents such as those in U.S. Pat. No. 4,546,154 have been employed. However, such polysiloxane agents do not produce sufficient number of releases to be commercially acceptable.

Fatty acids and their esters are also known for use as mold release agents. For example, U.S. Pat. No. 4,098,731 discloses the use of salts of saturated or unsaturated aliphatic or cycloaliphatic carboxylic acids having at least eight carbon atoms with tertiary amines which do not contain amide or ester groups as release agents for polyurethane foam production. Esterification reaction products of polysiloxanes and monocarboxylic or polycarboxylic acids, as shown in U.S. Pat. No. 4,024,090, also have been used as mold release agents. In addition, carboxylic acids and their derivatives have been employed as mold release agents. See U.S. Pat. Nos. 5,128,807, 4,058,492, 3,993,606 and 3,726,952. Esters of a fatty acid such as glycerol trioleate, olive oil and peanut oil as a processing aid, as shown in U.S. Pat. No. 4,130,698 also have been used. Such systems, however, produce only a minor improvement in release performance in SRIM systems.

U.S. Pat. No. 5,389,696 discloses a process for producing a molded foam part using an internal mold release agent which comprises (a) 1-10% of mixed esters comprising the reaction product of i) aliphatic dicarboxylic acids, ii) aliphatic polyols, and iii) monocarboxylic acids.

Lubricant compositions also have been used to produce a release effect. For example, U.S. Pat. No. 3,875,069 discloses lubricant compositions for use in shaping thermoplastic materials. These lubricant compositions include: (A) mixed esters of (a) aliphatic, cycloaliphatic and/or aromatic dicarboxylic acids, (b) aliphatic polyols and (c) aliphatic monocarboxylic acids with (B) esters of (1) dicarboxylic acids and long chained aliphatic monofunctional alcohols, (2) long chained aliphatic monofunctional alcohols and long-chained monocarboxylic acids and (3) full or partial esters of aliphatic polyols and long-chained aliphatic monocarboxylic acids. However, as with other internal release agents, the release materials disclosed in this patent has not demonstrated the ability to achieve consistently good results.

### DISCLOSURE OF THE INVENTION

The invention relates to internal mold release systems which employ an internal mold release agent that includes any one of fatty acids, fatty acid esters and metal carboxylates, and a poly(dimethylsiloxane) surfactant with the following formula:

(CH₃)₃Si—O—[(CH₃)₂Si—O—]ₙ—[CH₃—Si(R)—O—]ₘ—Si(CH₃)₃

wherein,

R=−(CH₂)₃—O—[EO]ₓ—R′;

R′ is H; C₁ to C₂₀ alkyl; or C₆ to C₂₅ aryl;

x is a number from greater than 1 up to about 24;

m is a number from 1 to about 25; and

n is a number from 0 to about 100.

Isocyanate compositions that employ the internal mold release agents and/or the surfactant, and isocyanate reactive compositions that employ the internal mold release agents and the surfactant also are disclosed. Reaction systems that employ the isocyanate reactive compositions also are disclosed.

The invention is especially useful in manufacture of shaped resin components by the structural reaction injection molding process (SRIM).

### MODES FOR CARRYING OUT THE INVENTION

Glossary of Chemicals

As used herein, the following trade name materials and terms are understood to have the following meanings:

| | |
|---|---|
| 1. Carbowax PEG 600 glycol | is a polyoxyethylene glycol of the formula H—(OCH₂CH₂)ₙ— |
| | OH where n is an average number of 13. Carbowax 600 is |
| | available from Union Carbide Chemicals and Plastics, |
| | MW = 600. |
| 2. DABCO ® 8800 catalyst | is a delayed action amine type catalyst from Air Products. |
| 3. Plasticolor DR2205 colorant | is a colorant available from Plasticolors Corp. |
| 4. KEMESTER ® 5721 product | is tridecyl stearate available from Witco Chemicals. |
| 5. LH-1 | is a paste wax that is commercially available from Chem- |
| | Trend |
| 6. Loxiol G71S product | is the reaction product of adipic acid, pentaerythritol, and |
| | oleic acid, having an acid number of less than 15 and a |
| | hydroxyl number of less than 15, available from Henkel; |
| 7. Niax L-6980 surfactant | is a poly(dimethylsiloxane) surfactant available from OSi |
| | Chemicals; |
| 8. POLYCAT ® 8 catalyst | is an N,N-dimethyl-cyclohexyl amine catalyst available |
| | from Air Products; |
| 9. Reactint X95AB dye | is a reactive dye from Milliken Chemical Co.; |
| 10. RUBINOL ® R015 product | is oxypropylated glycerol having an OH number of 650 |
| | available from Huntsman Polyurethanes; |
| 11. RUBINATE ® 8700 isocyanate | is a mixture of diisocyanato diphenylmethane isomers with |
| | oligomeric polymethylene polyphenylene polyisocyanates |
| | and has an NCO content of 31.5% from Huntsman |
| | Polyurethanes; |
| 12. Sylfat FA-1 fatty acid | is a tall oil fatty acid having an acid number of about 194, |
| | and saponification number of about 197, and having an |
| | iodine number of about 131 from Arizona Chemical Co., |
| | Panama City, FL. It is a mixture of linear aliphatic mono |
| | acids with an average number of carbons of 18. |
| 13. Unitol DSR fatty acid | is a tall oil fatty acid having an acid number of about 191, |
| | and saponification number of about 193, and having an |
| | iodine number of about 130 from Union Camp Corp. |
| | Unitol DSR is a mixture of linear aliphatic mono acids with |
| | an average number of carbons of 18. |
| 14. Functionalities | All functionalities described herein with respect to |
| | polymeric materials are “number average”. All |
| | functionalities described with respect to pure compounds |
| | are “absolute”. |
| 15. Molecular Weights | All molecular weights described herein with respect to |
| | polymeric materials are “number average”. All molecular |
| | weights described with respect to pure compounds are |
| | “absolute”. |

The present reaction systems include an A-side and a B-side. The A-side includes an isocyanate. The A-side also may include an internal mold release agent, a poly (dimethylsiloxane) surfactant, as well as one or more additives. The B-side includes an isocyanate reactive material. The B-side also can include an internal mold release agent, and a poly(dimethylsiloxane) surfactant. The B-side may further include chain extenders and/or cross-linking agents, blowing agents, catalysts as well as optional additives. Preferably, the A-side includes an isocyanate and, preferably the B-side includes an isocyanate reactive material together with chain extenders and/or cross-linking agents, blowing agents, catalysts as well as other additives.

The isocyanate reactive material employed in the b-side has a plurality of isocyanate-reactive groups and can be a combination of at least two isocyanate-reactive compounds. One of these isocyanate-reactive compounds optionally can be a softblock segment. The term “softblock” is well known to those in the art. It is the soft segment of a polyurethane, realizing that the polyurethane may encompass isocyanurate rings, urea or other linkages. Softblock segments useful in the present reaction system include those conventionally used in the art.

Isocyanate-reactive materials that furnish softblock segments are well known in the art. Such materials generally have a number average molecular weight of at least about 1500, preferably about 1500 to about 8000, a number-average equivalent weight of about 400 to about 4000, preferably about 750 to about 2500, and a number-average functionality of isocyanate-reactive groups of about 2 to about 10, preferably about 2 to about 4. Such materials include e.g., polyether or polyester polyols having primary or secondary hydroxyl groups. Preferably, the softblock segments are 0 to about 30 wt %, more preferably 0 to about 20 wt % of the isocyanate-reactive species of the composition containing a plurality of isocyanate-reactive groups. It is especially preferred that the isocyanate-reactive compound(s) have (a) 0 to about 20 wt % of at least one polyol having a molecular weight of about 1500 or greater and a functionality of about 2 to about 4; (b) about 70 wt % to about 98% wt % of at least one polyol having a molecular weight of about 200 to about 500 and a functionality of about 2 to about 6; and (c) about 2% to about 15 wt % of at least one polyol having a functionality of about 2 to about 4 and a number average molecular weight of less than about 200.

Suitable polyether polyols which can be employed in the B-side include those prepared by reacting an alkylene oxide, halogen-substituted or aromatic-substituted alkylene oxide or mixtures thereof with an active hydrogen-containing initiator compound.

Suitable alkylene oxides include, for example, ethylene oxide, propylene oxide, 1,2-butylene oxide, styrene oxide, epichlorohydrin, epibromohydrin, and mixtures thereof.

Suitable initiator compounds include water, ethylene glycol, propylene glycol, butanediol, hexanediol, glycerine, trimethylol propane, pentaerythritol, hexanetriol, sorbitol, sucrose, hydroquinone, resorcinol, catechol, bisphenols, novolac resins, phosphoric acid and mixtures thereof.

Suitable initiators also include, for example, ammonia, ethylenediamine, diaminopropanes, diaminobutanes, diaminopentanes, diaminohexanes, diethylenetriamine, triethylenetetramine, tetraethylenepentamine, pentamethylenehexamine, ethanolamine, aminoethylethanolamine, aniline, 2,4-toluenediamine, 2,6-toluenediamine, 2,4′-diaminodiphenylmethane, 4,4′-diaminodiphenylmethane, 1,3-phenylenediamine, 1,4-phenylenediamine, naphthylene-1,5-diamine, triphenylmethane 4,4′,4′″-triamine, 4,4′-di(methylamino)diphenylmethane, 1,3-diethyl-2,4-diaminobenzene, 2,4-diaminomesitylene, 1-methyl-3,5-diethyl-2,4-diaminobenzene, 1-methyl-3,5-diethyl-2,6-diaminobenzene, 1,3,5-triethyl-2,6-diaminobenzene, 3,5,3′,5′-tetra-ethyl-4,4′-diamino-diphenylmethane and amine aldehyde condensation products such as the polyphenylpolymethylene polyamines produced from aniline and formaldehyde and mixtures thereof.

Suitable polyester polyols include, for example, those prepared by reacting a polycarboxylic acid or anhydride with a polyhydric alcohol. The polycarboxylic acids may be aliphatic, cycloaliphatic, aromatic and/or heterocyclic and may be substituted (e.g., with halogen atoms) and/or unsaturated. Examples of suitable carboxylic acids and anhydrides include succinic acid; adipic acid; suberic acid; azelaic acid; sebacic acid; phthalic acid; isophthalic acid; terephthalic acid; trimellitic acid; phthalic acid anhydride; tetrahydrophthalic acid anhydride; hexahydrophthalic acid anhydride; tetrachlorophthalic acid anhydride; endomethylene tetrahydrophtalic acid anhydride; glutaric acid anhydride; maleic acid; maleic acid anhydride; fumaric acid; dimeric and trimeric fatty acids, such as those of oleic acid, which may be in admixture with monomeric fatty acids. Simple esters of polycarboxylic acids such as terephthalic acid dimethyl ester, terephthalic acid bisglycol ester and mixtures thereof may also be used.

Examples of suitable polyhydric alcohols include ethylene glycol, 1,2-propylene glycol; 1,3-propylene glycol; 1,3-, 1,4-, 1,2- and 2,3-butylene glycol; 1,6-hexane diol; 1,8-octane diol; neopentyl glycol; cyclohexane dimethanol (1,4-bis-hydroxylmethyl cyclohexane); 2-methyl-1,3-propane diol, glycerol; trimethylol propane; 1,2,6-hexane triol; 1,2,4-butane triol; trimethylol ethylene; pentaerythritol; quitinol; mannitol; sorbitol; methylglycoside; diethylene glycol; triethylene glycol; tetraethylene glycol; polyethylene glycols; dipropylene glycol; polypropylene glycols; dibutylene glycol; polybutylene glycols and the like. The polyesters may contain some terminal carboxy groups although preferably they are hydroxyl-terminated. It is also possible to use polyesters of lactones such as caprolactone, or hydroxy carboxylic acids such as hydroxy caproic acid or hydroxyacetic acid.

A preferred isocyanate-reactive compound for use in the B-side is a propylene oxide adduct of glycerol having a functionality of about 3 and an hydroxyl equivalent weight of about 86 such as RUBINOL®-015 product. Blends of RUBINOL®R-015 product with glycerol are also useful in the present invention. In this aspect, the weight ratio of RUBINOL®R-015 product to glycerol may be about 99:1 to about 50:50, preferably about 98:2 to about 90:10, more preferably about 95:5 to about 90:10. These blends can be about 70% to about 98%, preferably about 80% to about 95% by weight of the isocyanate-reactive compound(s) in the present reaction systems.

Internal mold release agents for use in the A-side or B-side include one of fatty acids, fatty acid esters, and metal carboxylates of fatty acids. Examples of release agents that may be employed are shown below. U.S. Pat. No. 5,529,739 shows using aspartic derivatives as release agents. The release agent corresponds to the formula:

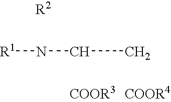

wherein R² represents hydrogen, the group R⁵—NH—CO—, or a C₁ to C₂₄ alkyl or substituted alkyl group, a C₃ to C₂₄ cycloalkyl or substituted cycloalkyl group, a C₂ to C₂₄ alkenyl or substituted alkenyl group, or a C₆ to C₂₄ aryl or substituted aryl group, and wherein R¹, R³, R⁴ and R⁵ may be the same or different and represent a C₁ to C₂₄ alkyl or substituted alkyl group, a C₃ to C₂₄ cycloalkyl or substituted cycloalkyl group, a C₂ to C₂₄ alkenyl or substituted alkenyl group, or a C₆ to C₂₄ aryl or substituted aryl group, with the proviso that at least one of R¹, R², R³, R⁴, R⁵ is a C₁₂ to C₂₄ alkyl or substituted alkyl group, or a C₁₂ to C₂₄ alkenyl or substituted alkenyl group, and with the further proviso that substituent groups are inert toward isocyanate groups at temperatures of 100° C. or less.

As disclosed in U.S. Pat. No. 5,529,739, the aspartic acid derivatives useful as release agents may be synthesized from dialkyl maleates and primary or secondary fatty chain monoamines in a Michael-type reaction wherein a dialkyl maleate is reacted with and a primary amine). In order to produce the compounds where R² is the group R⁵—NH—CO—, the product is reacted with a monoisocyanate.

Additional examples of internal mold release agents that may be employed include those shown in U.S. Pat. Nos. 5,389,696, 5,500,176, and 5,536,465. U.S. Pat. No. 5,389,696 shows an internal mold release agent that includes a) mixed esters comprising of the reaction product of i) aliphatic dicarboxylic acids, ii) aliphatic polyols, and iii) monocarboxylic acids with 12 to 30 carbon atoms in the molecule. This internal mold release agent may additionally include b) and/or c) wherein: b) represents the reaction product of N,N-dimethylpropylene diamine with a compound selected from the group of tall oil, C₈₋₂₀ monofunctional carboxylic acids, and mixtures of monofunctional carboxylic acids; and c) represents the reaction product of oleic acid, adipic acid, and pentaerythritol; with the proviso that the reaction product of a) is different than the reaction product of c).

U.S. Pat. No. 5,500,176 shows an internal mold release agent that includes mixed esters including the reaction product of i) aliphatic dicarboxylic acids, ii) aliphatic polyols, and iii) monocarboxylic acids with 12 to 30 carbon atoms in the molecule.

U.S. Pat. No. 5,536,465 shows internal mold release agents that include a zinc carboxylate containing from 8 to 24 carbon atoms, and a fatty acid.

Preferably, the internal mold release agent includes a mixture of (1) a fatty polyester, and (2) a fatty acid that is different that the fatty polyester. In general, each of these may be present in an amount of about 0.5% to about 5.0%, preferably about 1.5% to about 3.5%, and more preferably about 3% based upon the weight of the entire polymer system.

Suitable fatty polyesters used in the preferred internal mold release agents include polyesters having a number average molecular weight of about 500 to about 12,000, preferably about 800 to about 5000, more preferably about 1000 to about 4000, most preferably about 2000 to about 3000. Suitable fatty polyesters are mixed esters formed as the reaction product of three monomers: (1) a monofunctional monomer; (2) a difunctional monomer; and (3) a polyfunctional monomer (i.e., trifunctional or higher). The ‘functionality’ of these monomers arises from hydroxyl groups, acid groups, or derivatives thereof. Each of monomers (1), (2) and (3) may independently comprise from about 2 to about 54 and preferably about 2 to about 18 carbon atoms.

Suitable fatty polyesters include mixed esters formed as the reaction product of (i) aliphatic dicarboxylic acids, (ii) aliphatic polyols and (iii) fatty monocarboxylic acids wherein the monocarboxylic acid comprises about 12 to about 30 carbon atoms, preferably about 16 to about 20 carbon atoms. The preferred fatty polyester utilized in the preferred internal mold release agent is the reaction product of (i) adipic acid, (ii) pentaerythritol and (iii) oleic acid. A suitable compound is available as LOXIOL G-71 S from Henkel Corporation.

Suitable fatty acids for use in the preferred internal mold release agents include blends of linoleic acid and oleic acid, and other aliphatic carboxylic acids having eight or more carbons. Examples of suitable fatty acids of tall oil include Sylfat FA-1 and Unitol DSR fatty acids, preferably Unitol DSR fatty acid.

The preferred internal mold release agents may be prepared by any suitable method known to those skilled in the art. In general, the internal mold release agents may be prepared by mixing the fatty polyester and the fatty acid into the component of the reaction system containing the polyol of the “B side”. The fatty acid and the fatty polyester are generally not reacted prior to their addition to the B side of the reaction system.

The internal mold release agents may be present in the A-side or the B-side, preferably the B-side, in an amount of about 1.0% to about 50.0%, preferably about 3.0% to about 20.0%, most preferably about 13.0% by weight based on the total weight of the B-side. When ingredients of the internal mold release agent are placed in the A-side, it is preferred that those ingredients be inert toward isocyanates.

Poly(dimethylsiloxane) surfactants suitable for use with the internal mold release agents such as those described above can be prepared by the well known process of hydrosilation. In hydrosilation, an allyl terminated polyether is coupled with a polydimethyl siloxane bearing Si—H groups. The result is a polysiloxane-polyether copolymer bearing stable Si—C linkages between the polysiloxane backbone and the polyether side chains. See, for example, any of U.S. Pat. Nos. 4,857,583; 5,045,571; 4,242,466; 5,856,369; 5,492,939; 5,432,206; and 4,031,042.

The poly(dimethylsiloxane) surfactants useful with the internal mold release agents employed in the invention include those with the following formula:

(CH₃)₃Si—O—[(CH₃)₂Si—O—]ₙ—[CH₃—Si(R)—O—]ₘ—Si(CH₃)₃

wherein,

R=—(CH₂)₃—O-[EO]ₓ—R′;

R′ is H, C₁ to C₂₀ alkyl, or C₆ to C₂₅ aryl; preferably H or CH₃;

x is a number from greater than 1 up to about 24; preferably about 7;

m is a number from 1 to about 25; preferably about 11; and

n is a number from 0 to about 100; preferably about 47.

The product of m and x may vary from about 1 to about 600, preferably about 50 to about 200.

The poly(dimethylsiloxane) surfactant may be present in the A-side or the B-side, preferably the B-side, in an amount such that the poly(dimethylsiloxane)-polyoxyethylene surfactant contributes more than 0.006 moles of EO per 100 g of the polymer derived from the reaction system, preferably about 0.006 to about 0.050 mol EO/100 g polymer, more preferably about 0.006 mol EO/100 g polymer. The poly(dimethylsiloxane)-polyoxyethylene surfactant is preferably essentially free of oxyalkylene units derived from alkylene oxides other than ethylene oxide. The surfactant may be present in an amount of about 0.1% to about 10.0%, preferably about 0.2% to about 1.0%, most preferably about 0.85% by weight based on the total weight of the reaction system, exclusive of any reinforcement or fibers employed in the reaction system.

Suitable chain extenders for use in the B-side have a formula weight less than about 750, preferably about 62 to about 750, and a functionality of about 2. These chain extenders may be selected from polyols such as ethylene glycol, diethylene glycol, butanediol, dipropylene glycol and tripropylene glycol; aliphatic and aromatic amines such as 4,4′-methylene dianilines having a lower alkyl substituent positioned ortho to each N atom; and certain imino-functional compounds such as those disclosed in European Patent Applications Nos. 284 253 and 359 456, and certain enamino-functional compounds such as those disclosed in European Patent Application Nos. 359 456 having 2 isocyanate-reactive groups per molecule.

Suitable cross-linking agents for use in the B-side include glycerol, oxyalkylated glycerol, pentaerythritol, sucrose, trimethylolpropane, sorbitol, oxypropylated sucrose, and oxyalkylated polyamines. The functionality of the cross-linking agents may range from about 3 to about 8, preferably about 3 to about 4, and the molecular weight may vary between the same ranges as disclosed above with regard to the chain extender. A preferred class of crosslinking agents includes oxypropylated derivatives of glycerol having a number average molecular weight of about 200 to about 750, glycerol and mixtures thereof.

Suitable blowing agents which may be employed include physical blowing agents such as liquified gases such as nitrogen, carbon dioxide, and air; chlorofluorocarbons and hydrocarbons; and chemical blowing agents, such as water, hydroxyfunctional cyclic ureas, etc. The blowing agents may be used in amounts up to about 10%, preferably about 0.1 to about 5%, more preferably about 0.25 to about 4% based on the total weight of the B-side.

Suitable catalysts which may be employed in the B-side include tertiary amines, organometallic compounds and amides of saturated or unsaturated C₁₂-C₂₄ fatty acids and di, tri or tetra-aminoalkanes having at least one catalytic amino group and at least one reactive amino group. Fatty amido-amines having hydroxyl substituents also may be used. The catalysts are used in amounts necessary for a particular application which will be evident to one skilled in the art from the present disclosure. Examples of catalysts useful with the internal mold release agents of the invention include tertiary aliphatic amines such as N,N-dimethylcyclohexylamine, triethylene diamine, bis-(dimethylamino)-diethyl ether, N-ethyl-morpholine, N,N,N′,N′,N″-pentamethyl diethylenetriamine, N,N-dimethyl aminopropylamine and aliphatic tertiary amine-containing amides of carboxylic acids, such as the amides of N,N-dimethyl aminopropylamine with stearic acid, oleic acid, hydroxystearic acid and dihydroxystearic acid. Commercially available tertiary aliphatic amines include the POLYCAT® series of amines and the DABCO® series of amine catalysts both available from Air Products Inc.

Other suitable additives which may be employed include, for example, conventional additives such as colorants and flame retardants. Useful flame retardants include phosphonates, phosphites and phosphates such as tris-(2-chloroisopropyl) phosphate (TCPP), dimethyl methyl phosphonate, ammonium polyphosphate and various cyclic phosphates and phosphonate esters known in the art; halogen-containing compounds known in the art such as brominated diphenyl ether and other brominated aromatic compounds; melamine; antimony oxides, such as antimony pentoxide and antimony trioxide; zinc compounds such as zinc oxide; alumina trihydrate; and magnesium compounds such as magnesium hydroxide. The flame retardants may be used in any suitable amount which will be evident to those skilled in the art from the present disclaimers. For example, the flame retardant may be used in an amount of 0 to about 55% based on the total weight of the B-side. Other conventional additives generally used in the art may also be used. Examples of these additives include fillers such as calcium carbonate, silica, mica, wollastonite, wood flour, melamine, glass or mineral fibers, glass spheres, etc.; pigments; surfactants; and plasticizers. Such additives can be used in amounts which will be evident to one skilled in the art from the present disclosure.

The A-side may be an organic polyisocyanate having a number average isocyanate functionality of about 1.8 to about 4.0. Preferably, the number average isocyanate functionality is about 2.3 to about 3.0. Suitable organic polyisocyanates include any of the aliphatic, cycloaliphatic, araliphatic, or aromatic polyisocyanates known to those skilled in the art, especially those which are liquid at room temperature. Examples of suitable polyisocyanates include 1,6-hexamethylene diisocyanate, isophorone diisocyanate, 1,4-cyclohexane diisocyanate, 4,4′dicyclohexylmethane diisocyanate, 1,4-xylylene diisocyanate, 1,4-phenylene diisocyanate, 2,4-toluene diisocyanate, 2,6-toluene diisocyanate, 4,4′diphenylmethane diisocyanate (4,4′-MDI), 2,4′diphenylmethane diisocyanate (2,4′-MDI), polymethylene polyphenylene polyisocyanates (crude or polymeric MDI) and 1,5 naphthylene diisocyanate. Mixtures of these polyisocyanates also can be used. Polyisocyanate variants, i.e., polyisocyanates which have been modified by the introduction of urethane, allophanate, urea, biuret, carbodiimide, uretonimine, isocyanurate and/or oxazolidone residues also can be used in the A-side. Isocyanate-terminated prepolymers may also be employed. Such prepolymers are generally prepared by reacting an excess of polymeric MDI or pure MDI with polyols, including aminated polyols, imine- or enamine-modified polyols, polyether polyols, polyester polyols or polyamines. Psuedoprepolymers, which are a mixture of prepolymer and one or more monomeric di- or polyisocyanates, also may be used. Commercially available polyisocyanates useful in the present reaction systems include the RUBINATE® series of polymeric isocyanates available from Huntsman Polyurethanes, Inc. Aromatic polyisocyanates are preferred for use in the A-side. The most preferred aromatic polyisocyanates are 4,4′-MDI, 2,4′-MDI, polymeric MDI, MDI variants and mixtures thereof.

Addition of Surfactant

Poly(dimethylsiloxane) surfactant may be added to the A-side or the B-side, preferably the B-side. When employed in the B-side, the surfactant may first be combined with the internal mold release agent by any suitable method known to those skilled in the art to produce an internal mold release system. Typically, the poly(dimethylsiloxane) surfactant is blended with the internal mold release agent. The resulting blend then is added to the polyol component employed in the B-side. Alternatively, the internal mold release agent may be added to the polyol of the B-side followed by addition of the poly(dimethylsiloxane) surfactant. The poly(dimethylsiloxane) surfactant is about 1% to about 75% by weight of the internal mold release agent.

Preparation of Reaction System

Reaction systems which employ the A-side and the B-side may be prepared by any conventional method known in the art. For example, the A-side may be mixed with the B-side in conventional low or high pressure impingement mixing machines known in the art. In this aspect, the A-side and the B-side can be mixed at weight ratios such that the ratio of the number of isocyanate groups to isocyanate-reactive groups (commonly known as the index) is about 75 to about 150%, with the proviso that when catalysts for the trimerization of isocyanates are used, the index may extend up to about 500%. Preferably, the index is from about 90 to about 115, more preferably about 95 to about 105%. The combined weights of the internal mold release agent and poly(dimethylsiloxane) surfactant is about 0.55% to about 20% by weight, preferably about 2.0% to about 6% by weight based upon the total weight of the reaction system.

Manufacture of Molded Products

Reaction systems of the above-described A-side and B-side are especially suitable for use in SRIM processes, which utilize both closed molds and open molds. Preferably, products prepared by SRIM processes are made with a reinforcement mat pre-placed in a closed mold. Reinforcement mats may include, for example, glass mats, graphite mats, polyester mats, polyaramide mats such as KEVLAR mats, and mats made from fibrous materials. Suitable mats include random continuous strand mats made of glass fiber bundles, woven mats and oriented mats such as uniaxial or triaxial mats. During manufacture, the reaction system is injected into the mold with the mat. The resulting product is a mat-reinforced composite which is demolded after the reaction system cures.

SRIM composite products also may be produced by including reinforcing fibers in the A-side or B-side, preferably the B-side, of the reaction system. Suitable reinforcement materials include woven or non-woven structural fibers such as glass, carbon, metal, graphite, silicon carbide, alumina, titania, boron, cellulosic, lignocellulosic, aromatic polyamide, polyester, polyolefin and mixtures thereof. The final composite product may contain about 0.5 to about 95 wt %, preferably about 10 to about 70 wt % of reinforcing material. The diameter of the fibers may vary from about 0.001 mm to about 1.0 mm. The fibers may be optionally pretreated with sizing agents, coatings, adhesion promoters and other kinds of surface treatments known in the art.

The invention will now be illustrated by reference to the following non-limiting examples.

### EXAMPLES 1-10

In examples 1-10, as well as comparative examples 1 and 2, the B-side is prepared by blending all components listed for each example in a standard mixing vessel at room temperature.

The B-side and the A-side are supplied to a Krauss-Maffei ‘RIM-Star 16’ RIM machine equipped with an impingement mix head to prepare a reaction mixture. The mix head pressure employed to prepare the reaction mixture is 2200 psi. The resulting reaction mixture leaves the mixhead at ambient pressure.

In order to evaluate the release properties due to use of the internal mold release agents in combination with poly(dimethyl siloxane) surfactants, the top and bottom metal mold surfaces are prepared by removing solid contaminates with m-pyrol. The m-pyrol then is removed with mineral spirits. A coating of LH-1 paste wax then is applied to the metal mold surface. A continuous strand of E-glass fiber mat from Certain Teed Corp. that has an areal density of 1.0 ounce/ft² then is deposited onto the bottom metal mold surface. The composite products are made by the open pour process wherein the reaction system at 30° C. is poured into a mold heated to 82° C. having the glass fiber mat. The mold then is closed for 90 sec to cure the foam. Immediately thereafter, the mold is opened and the resulting composite part is released from the mold. Without cleaning or re-coating the mold surfaces, additional composite parts are made until a composite part fails to release from the mold surfaces. The number of releases obtained on consecutive molded parts, i.e., without further application of wax, is measured. The reaction systems evaluated and the number of releases obtained are shown in Table 1. All amounts in Table 1 are parts by weight.

In Table 1, comparative example 1 shows the use of an EO, PO-containing, non-capped surfactant. Comparative example 2 illustrates the effect of addition of EO to the B-Side in the form of a high EO polyol such as Carbowax PEG 600. In comparative example 2, Carbowax PEG 600 contributes an additional 0.0037 mols EO per 100 gm total polymer and surfactant A contributes 0.0048 mols EO per 100 gm total polymer.

Examples 1-4, and 6 show the use of high EO, non-PO poly(dimethylsiloxane)surfactant. Example 5 shows the use of a low EO, non-PO poly(dimethylsiloxane)surfactant. Example 7 shows use of very high EO, non-PO poly(dimethylsiloxane)surfactant. Example 8 shows use of a high EO, PO-containing, methyl capped poly(dimethylsiloxane)surfactant. Example 9 shows use of large amount of high EO, PO-containing, non-capped poly(dimethylsiloxane)surfactant. Example 10 shows the effect of blending an internal mold release agent enhancing surfactant with a conventional non-enhancing surfactant.

TABLE 1

| | Example/Component | | | | | |
|---|---|---|---|---|---|---|
| | Comp. | Comp. | | | | |
| | Ex. 1 | Ex. 2 | Ex. 1 | Ex. 2 | Ex. 3 | Ex. 4 |
| B-Side | | | | | | |
| RUBINOL R015 product | 100.0 | 100.0 | 100.0 | 100.0 | 100.0 | 100.0 |
| Glycerol | 7.5 | 7.5 | 7.5 | 7.5 | 7.5 | 7.5 |
| Carbowax PEG 600 | 0.0 | 4.16 | 0.0 | 0.0 | 0.0 | 0.0 |
| glycol | | | | | | |
| POLYCAT 8 catalyst | 3.5 | 3.5 | 3.5 | 3.5 | 3.5 | 3.5 |
| DABCO 8800 catalyst | 1.0 | 1.0 | 1.0 | 1.0 | 1.0 | 1.0 |
| Unitol DSR product | 6.5 | 6.5 | 6.5 | 6.5 | 6.5 | 6.5 |
| Loxiol G71S product | 10.0 | 10.0 | 10.0 | 10.0 | 10.0 | 10.0 |
| Kemester 5721 product | 1.1 | 1.1 | 1.1 | 1.1 | 1.1 | 1.1 |
| Plastic Color DR-220 | 1.8 | 1.8 | 2.0 | 1.0 | 1.0 | 1.0 |
| Surfactant A | 2.0 | 2.0 | 0.0 | 0.0 | 0.0 | 0.0 |
| Niax L-6980 surfactant | 0.0 | 0.0 | 1.5 | 1.5 | 2.5 | 3.0 |
| DC-5357 | 0.0 | 0.0 | 0.0 | 0.0 | 0.0 | 0.0 |
| Surfactant B | 0.0 | 0.0 | 0.0 | 0.0 | 0.0 | 0.0 |
| Surfactant C | 0.0 | 0.0 | 0.0 | 0.0 | 0.0 | 0.0 |
| Niax L-5340 product | 0.0 | 0.0 | 0.0 | 0.0 | 0.0 | 0.0 |
| Water | 1.15 | 1.15 | 1.6 | 1.15 | 1.15 | 1.16 |
| A-SIDE | | | | | | |
| RUBINATE 8700 | | | | | | |
| isocyanate | | | | | | |
| A/B | 1.63 | 1.59 | 1.66 | 1.64 | 1.63 | 1.62 |
| EO moles from surfactant | .0047 | .0048 | .0038 | .0040 | .0065 | .0079 |
| per 100 gm of total | | | | | | |
| polymer | | | | | | |
| PO moles from surfactant | .0011 | .0011 | 0.0 | 0.0 | 0.0 | 0.0 |
| per 100 gm of total | | | | | | |
| polymer | | | | | | |
| Surfactant Capping | None | None | None | None | None | None |
| Result¹ | 45 | 50 | 134 | 105 | 205 | >323² |
| | Example/Component | | | | | |
| | Ex. 5 | Ex. 6 | Ex. 7 | Ex. 8 | Ex. 9 | Ex. 10 |
| B-Side | | | | | | |
| RUBINOL R015 product | 100.0 | 100.0 | 100.0 | 100.0 | 100.0 | 100.0 |
| Glycerol | 7.5 | 7.5 | 7.5 | 7.5 | 7.5 | 7.5 |
| Carbowax PEG 600 | 0.0 | 0.0 | 0.0 | 0.0 | 0.0 | 0.0 |
| glycol | | | | | | |
| POLYCAT 8 catalyst | 3.5 | 3.5 | 3.5 | 3.5 | 3.5 | 3.5 |
| DABCO 8800 catalyst | 1.0 | 1.0 | 1.0 | 1.0 | 1.0 | 1.0 |
| Unitol DSR product | 6.5 | 6.5 | 6.5 | 6.5 | 6.5 | 6.5 |
| Loxiol G71S product | 10.0 | 10.0 | 10.0 | 10.0 | 10.0 | 10.0 |
| Kemester 5721 product | 1.1 | 1.1 | 1.1 | 1.1 | 1.1 | 1.1 |
| Plastic Color DR-220 | 1.0 | 1.0 | 1.0 | 1.0 | 1.0 | 1.0 |
| Surfactant A | 0.0 | 0.0 | 0.0 | 0.0 | 4.0 | 1.05 |
| Niax L-6980 surfactant | 0.0 | 0.0 | 0.0 | 0.0 | 0.0 | 1.05 |
| DC-5357 | 1.5 | 0.0 | 0.0 | 0.0 | 0.0 | 0.0 |
| Surfactant B | 0.0 | 1.5 | 0.0 | 0.0 | 0.0 | 0.0 |
| Surfactant C | 0.0 | 0.0 | 1.5 | 0.0 | 0.0 | 0.0 |
| Niax L-5340 product | 0.0 | 0.0 | 0.0 | 3.87 | 0.0 | 0.0 |
| Water | 1.15 | 1.15 | 1.15 | 1.15 | 1.16 | 1.15 |
| A-SIDE | | | | | | |
| RUBINATE 8700 | | | | | | |
| isocyanate | | | | | | |
| A/B | 1.64 | 1.64 | 1.64 | 1.64 | 1.61 | 1.64 |
| EO moles from surfactant | .0037 | .0052 | .0058 | .0095 | .0093 | .0068 |
| per 100 gm of total | | | | | | |
| polymer | | | | | | |
| PO moles from surfactant | 0.0 | 0.0 | 0.0 | .0048 | .0022 | .0008 |
| per 100 gm of total | | | | | | |
| polymer | | | | | | |
| Surfactant Capping | None | None | None | Methyl | None | None |
| Result¹ | 55 | 129 | >294³ | 125 | 65 | 89 |

¹Number of parts (successive moldings) produced prior to release failure.
²Test terminated after 323 releases without failure to release.
³Test terminated after 294 releases without failure to release.

As can be seen from Table 1, surprising improvements in release characteristics are obtained when internal mold release agents, in combination with poly(dimethylsiloxane) surfactant as disclosed above, are employed.

What is claimed:

1. A reaction system for producing a polymer comprising:
a) a polyisocyanate composition;
b) a polyfunctional isocyanate reactive composition;
c) an internal mold release composition, said internal mold release composition containing:
i) a fatty polyester, and
ii) a fatty acid which is different from the fatty polyester;
d) a poly(dimethylsiloxane)-polyoxyethylene surfactant; and optionally
e) a catalyst suitable for promoting a polymer-forming reaction between the polyisocyanate composition and the polyfunctional isocyanate reactive composition;
wherein the polyisocyanate composition and the polyfunctional isocyanate reactive composition are present in proportions suitable for the formation of a polymer; and
wherein the poly(dimethylsiloxane)-polyoxyethylene surfactant is essentially free of oxyalkylene units derived from alkylene oxides other than ethylene oxide and is present in the reaction system in an amount such that the poly(dimethylsiloxane)-polyoxyethylene surfactant contributes more than 0.006 moles of EO per 100 g of the polymer derived from the reaction system.

2. The reaction system of claim 1 wherein the poly(dimethylsiloxane)-polyoxyethylene surfactant has the following formula:
(CH₃)₃Si—O—[(CH₃)₂Si—O—]ₙ—[CH₃—Si(R)—O—]ₘ—Si(CH₃)₃
wherein,
R=—(CH₂)₃—O—[EO]ₓ—R′;
R′is H; C₁ to C₂₀ alkyl; or C₆ to C₂₅ aryl;
x is a number from greater than 1 up to about 24;
m is a number from 1 to about 25; and
n is a number from 0 to about 100.

3. The reaction system of claim 1 wherein the fatty polyester comprises a reaction product of:
(i) an aliphatic dicarboxylic acid;
(ii) an aliphatic polyol; and
(iii) a fatty monocarboxylic acid,
wherein the fatty monocarboxylic acid has from 12 to about 30 carbon atoms.

4. The reaction system of claim 3 wherein the fatty polyester comprises a reaction product of adipic acid, pentaerythritol, and oleic acid.

5. The reaction system of claim 1 wherein the fatty acid is an aliphatic carboxylic acid having eight or more carbon atoms.

6. The reaction system of claim 1 wherein the fatty acid comprises at least one member selected from the group consisting of oleic acid and linoleic acid.

7. The reaction system of claim 1 wherein the catalyst comprises a tertiary amine catalyst.

8. The reaction system of claim 1 wherein the polyfunctional isocyanate reactive composition comprises one or more polyols.

9. The reaction system of claim 2 wherein x is 7, m is 11, and n is 47.

10. The reaction system of claim 2 wherein R′ is selected from the group consisting of H and CH₃.

11. The reaction system of claim 2 wherein R′ is H.

12. The reaction system of claim 2 wherein n is greater than 0.

13. The reaction system of claim 9 wherein R′ is selected from the group consisting of H and CH₃.

14. The reaction system of claim 13 wherein R′ is H.

15. A fiber reinforced polymeric molding produced from the reaction system of claim 1.

16. A mat reinforced polymeric molding produced from the reaction system of claim 1.
